(19) United States
(12) Patent Application Publication
(10) Pub. No.: US 2018/0276626 A1
(43) Pub. Date: Sep. 27, 2018

(54) BLOCKCHAIN SYSTEMS AND METHODS

(71) Applicant: Dappsters, LLC, Festus, MO (US)

(72) Inventor: Brendan Laiben, Festus, MO (US)

(21) Appl. No.: 15/928,072

(22) Filed: Mar. 21, 2018

Related U.S. Application Data
(60) Provisional application No. 62/474,378, filed on Mar. 21, 2017.

(51) Int. Cl. G06Q 20/06; H04L 9/32; G06Q 20/38

(52) U.S. Cl. CPC G06Q 20/0658; H04L 9/3213; G06Q 2220/00; H04L 2209/56; H04L 2209/38; G06Q 20/3829

(57) ABSTRACT

Systems and methods for micro-transactions using virtual currency via a blockchain. A central authority server provides a shadow ledger to track verified but unposted transactions with respect to users of the virtual currency economy. New proposed transactions are checked against both the master records in the blockchain database and the shadow ledger to confirm that, when posted to the blockchain, they will be valid. Confirmed transactions are authenticated via tokens provided to users, who then remit the tokens to participants in exchange for access to content (e.g., paywall content, ad-free content, etc.). Users may acquire virtual currency through similar micro-transactions conducted in reverse. The unposted, cached transactions are then posted to the blockchain in bulk.

### CROSS-REFERENCE TO RELATED APPLICATIONS

This case claims benefit of U.S. Provisional Patent Application No. 62/474,378, filed Mar. 21, 2017, the entire disclosure of which is incorporated herein by reference.

### BACKGROUND

### 1. Field of the Invention

This disclosure is related to the field of databases, specifically to systems and methods for implementing a microtransaction platform on a blockchain.

### 2. Description of the Related Art

The modern Internet economy is built on advertising. For various historical and cultural reasons, Internet users expect most Internet-based services, ranging from on-line banking to news sites, to be free. The expectation that everything on-line is free is now so pervasive that users balk at being asked to pay even $1.00 for a mobile device application.

Further, even if users were willing to pay a modest fee, the energy overhead of acquiring enough information from the user to charge the fee is relatively high. Users must provide personally identifiable information, including name, address, and phone number, as well as a form of payment, typically via a payment card such as a credit or debit card. For new or small operators who are not yet well-known and trusted, users may be reluctant to provide such personal and financial information. Even for established enterprises, a user still may have privacy concerns or be unwilling to enter his or her information, verify the account, and enter payment card information.

However, providing Internet services still requires computers, bandwidth, storage, and electricity, and these things cost money. To cover these costs, and perhaps even turn a profit, service providers have increasingly turned to passive revenue generation techniques, primarily in the form of advertising, which now dominates the Internet.

Advertising-based revenue inserts advertisements into web content (or application software), exposing the user to the advertising while the user consumes the desired content or services. Because payment to the service provider is usually based on click-through rate, advertisers and website designers employ design techniques designed to entice or even trick users into clicking on ads. Such techniques obscure where real content ends and advertising begins, such as by breaking stories into multiple pages and providing a button to move to the next page, but then also inserting advertisements with similar-looking buttons. Users quickly skimming over the page to find the button to click for the next page may then mistakenly click the arrow in the ad, causing the advertisement to load and generating a click.

Other techniques include “background” ads situated “behind” the main content pane. When a user clicks anywhere outside the main content pane, the click registers and the ad loads. Users often click the background area of a web site to reset window focus (because the foreground is dominated by ads they want to avoid), generating unintended clicks.

Advertising revenue pays for blogs, music, videos, podcasts, and every type of consumable media on the Internet. According to a recent report, online advertising revenue totaled $59.6 billion in 2015 alone. However, the intrusive and sometimes deceptive nature of on-line advertising has caused users to turn increasingly to ad-blocking technology. Ad-blockers inhibit or prevent advertisements from appearing at all, and the use of such technology is increasing. According to one report, the use of ad-blockers increased by 41% from 2014 to 2015, and is estimated to have cost websites and advertisers over $20 billion in 2016.

The use of ad-blockers is motivated by both the desire to eliminate an annoyance, as well as privacy concerns. It is well-understood in the marketing industry that users are more receptive to, and interested in, marketing materials that are relevant to them. Advertisers thus have turned to data mining techniques to track on-line activity and use computer algorithms to guess which products or services each user may be interested in, and then deliver targeted advertising promoting those products and services. However, this often causes users to feel uneasy, like they are “being watched” online, and may motivate them to install ad-blocking technology.

Advertisers have responded with technology which can detect ad-blockers and disable the desired content or services unless the ad-blockers are disabled. Other advertisers have simply increased the amount of advertising on each page, pushing the advertising burden onto users who do not use ad-blockers. However, this only further interferes with good design and exacerbates the use of cluttered, slow, unattractive, unresponsive, hard-to-read web sites full of “click-bait.”

Given the option, most people would rather not watch advertising at all. For example, one study found that ninety percent of people skip ads ahead of online video content. Further, ad saturation has negatively impacted effectiveness. In one study, sixty-eight percent of people recall less than five ads they see in a week, which is less than 0.02% of the estimated 28,000 ads a typical Internet user is exposed to weekly. Although personalized ads are more effective, privacy concerns can deter potential customers, and advertisers are scrambling to come up with more palatable methods of advertising.

Developers and advertisers have a symbiotic nature, but their relationship is not perfect. Developers typically rely on advertisers to generate income, and advertisers rely on developers' websites to generate traffic and views. Some developers prefer to user subscriptions to pay for their websites, like Netflix™ or HBOGo™, but subscriptions again require the user to provide personal information and a payment method, and require a relatively large amount of money for a user who may only want one specific service. Developers could charge per use of a service, but transaction fees for such small payment amounts will reduce or eliminate profit margins. Even the developers of certain ad blocking techniques have partnered with advertisers, replacing the blocked ads for ads approved by their business partners.

The battle between advertisers and users wages onward, and users continue to pay the price, as none of these solutions addresses the real problem: users do not want to provide personal information, financial data, and/or a significant transaction fee merely to view content or use basic web services, and do not want to have advertising forced upon them, either. What is needed in the art is a way for users to make micropayments in a convenient, cost-effective manner that does not compromise user privacy.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is a method for immediate validation of a blockchain transaction comprising: providing a blockchain network operated in accordance with a ruleset; providing a first computer; providing a second computer; providing a first public key identifying a first account on the blockchain network, the first public key being associated with the first computer; providing a second public key identifying a second account on the blockchain network, the second public key being associated with the second computer; providing a central authority server, the central authority server being a node in the blockchain network and operating a shadow ledger for the blockchain network in accordance with the ruleset; receiving, at the second computer, the first public key and a transaction request using the public key; receiving, at the central authority server, an access token for the second computer and data for the transaction request, the data comprising at least the first public key and the second public key; the central authority server verifying, based on the access token, the first public key, and the second public key that the transaction is valid on the blockchain network according to the ruleset; and receiving, at the second computer, a result of the verifying step indicating that the transaction is valid.

In an embodiment of the method, the blockchain network implements a cryptocurrency.

In a further embodiment of the method, the blockchain network further implements a virtual machine configured to execute smart contracts.

In a further embodiment of the method, the central authority server includes a first private key corresponding to the first public key and formed using asymmetric cryptography.

In a further embodiment of the method, the transaction request comprises a request to perform a programmatically verifiable activity.

In a further embodiment of the method, the method further comprises: conducting the requested transaction; and at the central authority center, posting the transaction to the shadow ledger.

In a further embodiment of the method, the method further comprises: repeating the receiving steps, the verifying steps, the conducting step, and the posting step a plurality of times such that the shadow ledger comprises a plurality of transactions; and posting the plurality of transactions in the shadow ledger to the blockchain.

In a further embodiment of the method, the method further comprises receiving, at the second computer, a receipt for the conducted transaction.

In a further embodiment of the method, the verifying step comprises verifying that the transaction is permitted by the ruleset as applied to the combination of the blockchain and the shadow ledger.

In a further embodiment of the method, the transaction data further includes an amount of a virtual currency.

Also described herein, among other things, is a method for immediate validation of a blockchain transaction comprising: providing a blockchain network operated in accordance with a ruleset; providing a first computer; providing a second computer hosting a resource; providing a first public key identifying a first account on the blockchain network, the first public key being associated with the first computer, providing a second public key identifying a second account on the blockchain network, the second public key being associated with the second computer; providing a central authority server, the central authority server being a node in the blockchain network and operating a shadow ledger for the blockchain network in accordance with the ruleset; receiving, at the second computer, a request for the resource; receiving, at the first computer from the second computer, transaction data for a transaction to access to the content, the transaction data including the second public key; receiving, at the central authority server from the first computer, the first public key and a transaction request including the transaction data and the second public key; the central authority server verifying, based on the received transaction request, the first public key, and the second public key that the transaction is valid on the blockchain network according to the ruleset; receiving, at the second computer from the central authority server, a result of the verifying step indicating that the transaction is valid; receiving, at the central authority server from the second computer, an authentication token for the permitted transaction; receiving, at the first computer from the central authority server, the authentication token; receiving, at the second computer from the first computer, the authentication token; and the first computer accessing the resource hosted by the second computer.

In a further embodiment of the method, the blockchain network further implements a virtual machine configured to execute smart contracts.

In a further embodiment of the method, the central authority server includes a first private key corresponding to the first public key and formed using asymmetric cryptography.

In a further embodiment of the method, the receiving, at the first computer from the central authority server, the authentication token further comprises receiving, at the first computer from the central authority server, a receipt for the transaction.

In a further embodiment of the method, the resource is modified content of a web page containing marketing content, the modified content omitting the marketing content.

In a further embodiment of the method, the resource is an offer or sale of goods or services.

In a further embodiment of the method, the method further comprises at the central authority center, posting the transaction to the shadow ledger.

In a further embodiment of the method, the method further comprises: repeating the receiving steps, the verifying step, and the accessing step a plurality of times such that the shadow ledger comprises a plurality of transactions; and posting the plurality of transactions in the shadow ledger to the blockchain.

In a further embodiment of the method, the transaction data includes an amount of a virtual currency.

In a further embodiment of the method, the verifying step comprises verifying that the transaction is permitted by the ruleset as applied to the combination of the blockchain and the shadow ledger.

### BRIEF DESCRIPTION OF THE DRAWINGS

FIGS. 1A, 1B, 1C, 1D, 1E, 1F and 1G depict an embodiment of a blockchain system according to the present disclosure.

FIG. 2 depicts an embodiment of systems and methods for a central authority to communicate with a blockchain system, according to the present disclosure.

FIG. 3 depicts an embodiment of systems and methods for a central authority to communicate with a blockchain network, as well as with a user, according to the present disclosure.

FIG. 4 depicts an embodiment of systems and methods for a central authority to communicate with a blockchain network, as well as with a user, and for interaction with a third-party participant computer, according to the present disclosure.

FIG. 5 depicts an embodiment of systems and methods for a central authority to communicate with a blockchain network, as well as with a user, and for interaction with a third-party participant computer according to the present disclosure.

FIG. 6 depicts an embodiment of systems and methods for a central authority to communicate with a blockchain network, as well as with a user, and for interaction with a third-party participant computer, according to the present disclosure.

FIG. 7 depicts a flowchart having an embodiment of systems and methods according to the present disclosure.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and apparatus. As various changes could be made in the above constructions without departing from the scope of the disclosures, it is intended that all matter contained in the above description or shown in the accompanying drawings shall be interpreted as illustrative and not in a limiting sense.

The systems and methods described herein enable advertisers to economically sell advertisement to a user in a rewards- or points-based system implemented via a blockchain network, generally as smart contracts. Users can receive, store, and share or send rewards on-demand in exchange for reduced advertisements, ad-free browsing, or other incentives. However, the user need not directly use, or even be aware of, the underlying blockchain.

Described herein are systems and methods for an on-line, verifiable payment system that facilitates both manual and automatic payment with transaction costs as small as fractions of a cent. The systems and methods include a financial accounting system that uses smart contract technology and a centralized authority performing blockchain transactions on behalf of multiple independent users, and using bulk processing of transactions to reduce substantially the associated transaction fees, in some cases to fractions of a penny.

The following definitions generally apply to this disclosure and should be understood in both the context of client/server computing generally, as well as the particular environment of a blockchain network. These definitions, and other terms used herein, should also be understood in the context of leading white papers pertaining to the subject matter. These include, but are not necessarily limited to, Bitcoin: A Peer-to-Peer Electronic Cash System (Satoshi Nakamoto 2008). It will be understood by a person of ordinary skill in the art that the precise vocabulary of blockchains is not entirely settled, and although the industry has established a general shared understanding of the meaning of the terms, reasonable variations may exist.

As used herein, the term “asset” means anything that can be owned or controlled to produce value.

As used herein, “asymmetric key encryption,” also known as “public key encryption,” “public key cryptography,” and “asymmetric cryptography,” means a cryptographic system that uses pairs of mathematically related keys, one public and one private, to authenticate messages. The “private key” is kept secret by the sending of a message or document and used to encrypt the message or document. The “public key” is shared with the public and can be used to decrypt the message or document.

As used herein, the term “blockchain” means a distributed database system comprising a continuously-growing list of ordered records (“blocks”) shared across a network. In a typical embodiment, the blockchain functions as a shared transaction ledger.

As used herein, the term “blockchain network” means the collection of nodes interacting via a particular blockchain protocol and rule set.

As used herein, the term “block” means a record in a continuously-growing list of ordered records that comprise a blockchain. In a typical embodiment, a block comprises a collection of confirmed and validated transactions, plus a nonce.

As used herein, the term “consensus” refers to a computational agreement among nodes in a blockchain network as to the content and order of blocks in the blockchain.

As used herein, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including but not limited to eyewear, wristwear, pendants, fabrics, and clip-on devices. A “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies. It is also well known to those of ordinary skill in the art that the functionality of a single computer may be distributed across a number of individual machines. This distribution may be functional, as where specific machines perform specific tasks; or balanced, as where each machine is capable of performing most or all functions of any other machine and is assigned tasks based on its available resources at a point in time. Thus, the term “computer” as used herein can refer to a single, standalone, self-contained device or to a plurality of machines working together or independently as a logical computer, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

As used herein, the term “database” means a computer-accessible, organized collection of data. Databases have been used for decades to format, store, access, organize, and search data. Traditionally, databases were stored on a single storage medium controlled by a single computer processor, such as a fixed disk or disk array. However, databases may also be organized in a “distributed” fashion, wherein the database is stored on a plurality of storage devices, not all of which are necessarily operated by a common processor. Instead, distributed databases may be stored in multiple component parts, in whole or part, dispersed across a network of interconnected computers.

As used herein, “difficulty” means proof-of-work mining, or the expected total computational effort necessary to verify the next block in a blockchain. Difficulty is generally determined by the verification rules of the blockchain and may be adjusted over time to cause the blockchain to grow (e.g., new blocks to be verified and added) at a desired rate. For example, in the Bitcoin™ blockchain network, the difficulty adjusts to maintain a block verification time of about ten minutes across the blockchain network.

As used herein, the term “digital signature” means a mathematically-based system for demonstrating the authenticity of a message or document by ensuring that it was sent from the identified sender and not tampered with by an intermediary. Blockchains generally use asymmetric key encryption to implement digital signatures.

As used herein, the term “fork” means a split in a blockchain where two different valid successor blocks have been mined and are present in the blockchain, but consensus has not yet been reached as to which fork is correct. This type of fork is also referred to as a “soft fork,” and is automatically resolved by consensus over time. A “hard fork” is the forced imposition of a fork by manual intervention to invalidate prior blocks/transactions, typically via a change to the blockchain rules and protocol.

As used herein, the term “gas” means an execution fee charged on a blockchain to execute virtual code, typically in connection with a smart contract. Gas is generally decoupled from cryptocurrency in the blockchain network, due to market fluctuations in the value of the cryptocurrency. This is because the computational cost represented by gas is generally constant.

As used herein, the term “genesis block” means the very first block in a blockchain.

As used herein, the term “hash” means a cryptographic algorithm to produce a unique or effectively unique value, properly known as a “digest” but sometimes informally referred to itself as a “hash,” usually from an arbitrary, variable-sized input. Hashes are repeatable and unidirectional, meaning the algorithm always produces the same digest from the same input, but the original input cannot be determined from the digest. A change to even one byte of the input generally results in a very different digest, obscuring the relationship between the original content and the digest. SHA256 (secure hash algorithm) is an example of a widely used hash.

As used herein, the term “ledger” means the append-only records stored in a blockchain. The records are immutable and may hold any type of information, including financial records and software instructions.

As used herein, the term “media” means one or more volatile and/or non-volatile computer readable medium. The medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As used herein, the term “mining” means the process by which new transactions to add to the blockchain are verified by solving a cryptographic puzzle. In a proof-of-work blockchain network, mining involves collecting transactions reported to the blockchain network into a “block,” adding a nonce to the block, then hashing the block. If the resulting digest complies with the verification condition for the blockchain system (i.e., difficulty), then the block is the next block in the blockchain.

As used herein, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network. It should be noted that the term “blockchain network” as used herein usually means refers to a subset of

As used herein, the term “node” means each copy of the ledger in the blockchain network.

As used herein, “nonce” means an arbitrary number or other data used once and only once in a cryptographic operation. A nonce is often, but not necessarily, a random or pseudorandom number.

As used herein, “proof-of-stake” means a mining system in which the production and verification of a block is pseudo-randomly awarded to a candidate miner, or prioritized list of candidate miners, who have invested a valuable stake in the system which can be collected by the blockchain network if the produced block is later deemed invalid. The stake functions as a deterrent against fraudulent blocks.

As used herein, “proof-of-work” means a mining system in which the difficulty of finding a nonce that solves the cryptographic puzzle is high enough that the existence of a block compliant with the verification rules is itself sufficient proof that the block is not fraudulent.

As used herein, “smart contracts” means computer programs executed by a computer system that facilitate, verify, or enforce the negotiation and performance of an agreement using computer language rather than legal terminology. Smart contracts may be verified and executed on virtual computer systems distributed across a blockchain.

As used herein, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory. Program code embodied on a computer readable medium may be transmitted using any appropriate medium, including but not limited to wireless, wireline, optical fiber cable, RF, etc., or any suitable combination of the foregoing.

As used herein, the term “transaction” means an asset transfer onto or off of the ledger represented by the blockchain, or a logically equivalent addition to or deletion from the ledger.

As used herein, the term “transaction fee” means a fee imposed on some transactions in a blockchain network. The amount of the transaction fee is awarded to the miner who successfully mines the next block containing that transaction.

As used herein, the term “wallet” means a computer file or software of a user that allows a user of a blockchain network to store and spend cryptocurrency by submitting transactions to the blockchain network. A wallet is usually itself protected by a cryptography via a private key.

As used herein, the terms “web,” “web site,” “web server,” “web client,” and “web browser” refer generally to computers programmed to communicate over a network using the HyperText Transfer Protocol (“HTTP”), and/or similar and/or related protocols including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

It will be understood by one of ordinary skill in the art that common parlance in the computing industry refers to a “user” accessing a “site.” This usage is intended to represent technical access to an online server by a user via a user computer. That is, the reference to a “user” accessing a “server” refers to the user manipulating or otherwise causing client software to communicate over a telecommunications network with server software. This also typically means that the user's client software is running on a client computer system and accessing the server computer system remotely. Although it is possible that a user may directly access and use the server via the server hardware, and without use of a client system, this is not the typical use case in a client/server architecture.

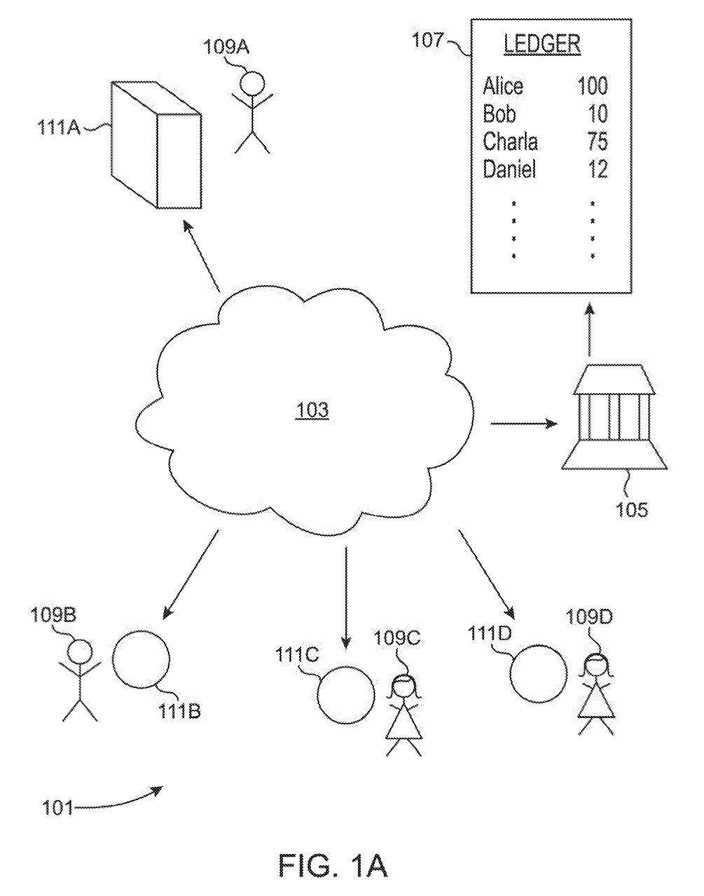

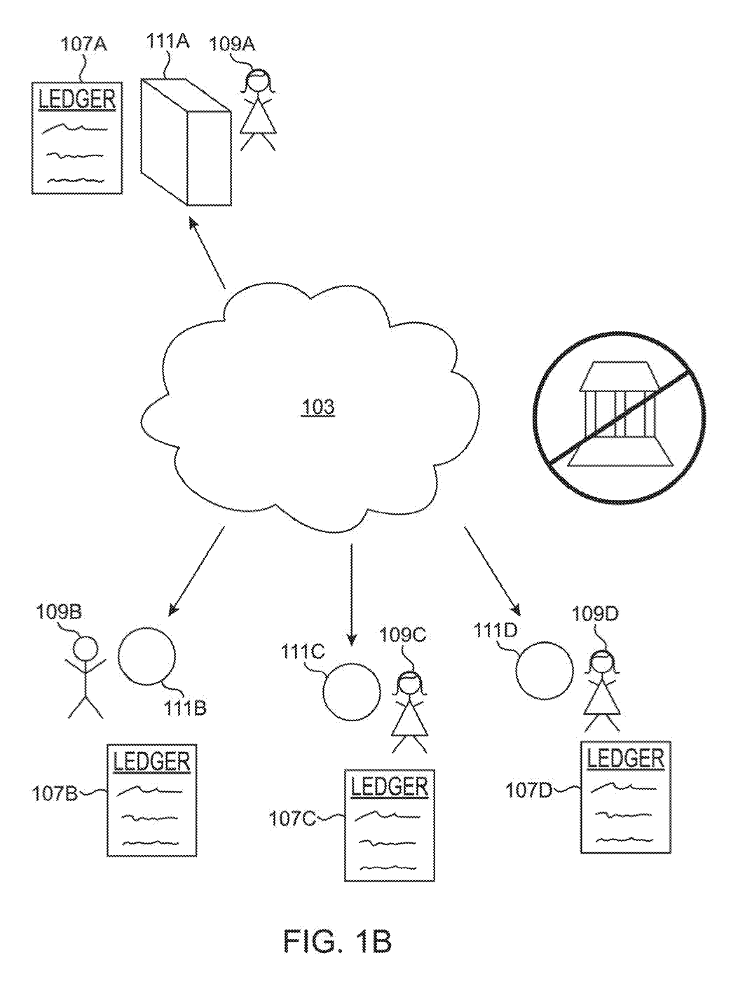

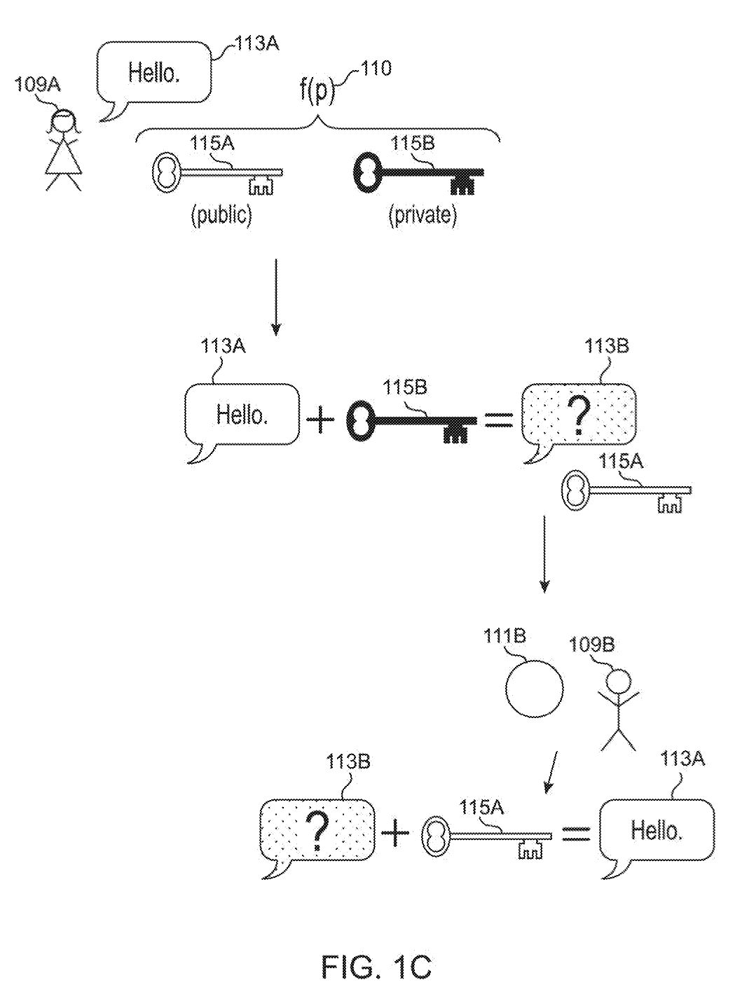

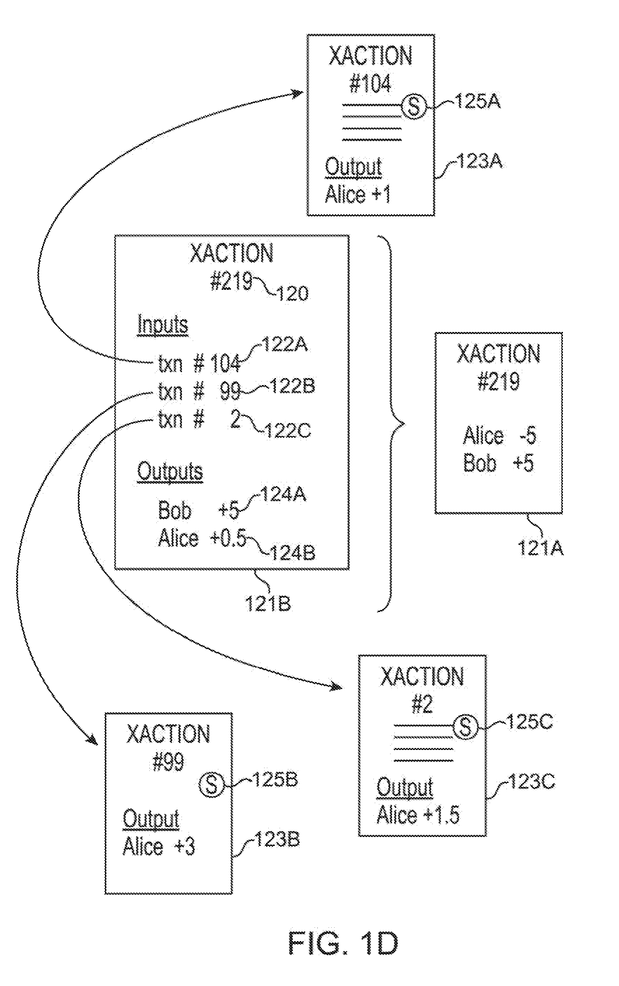

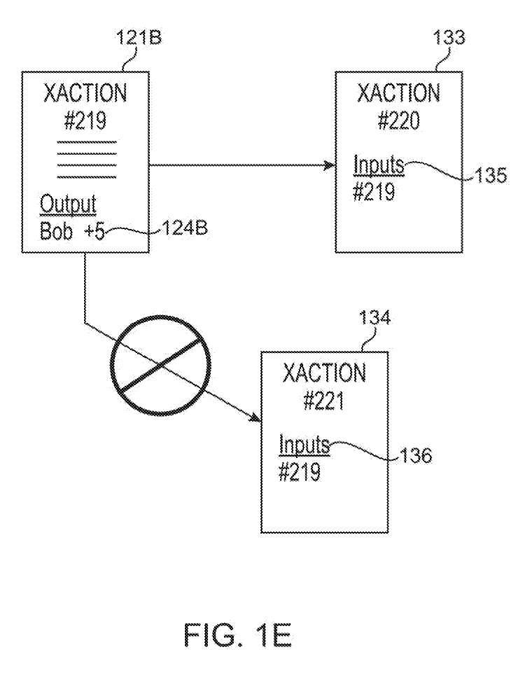

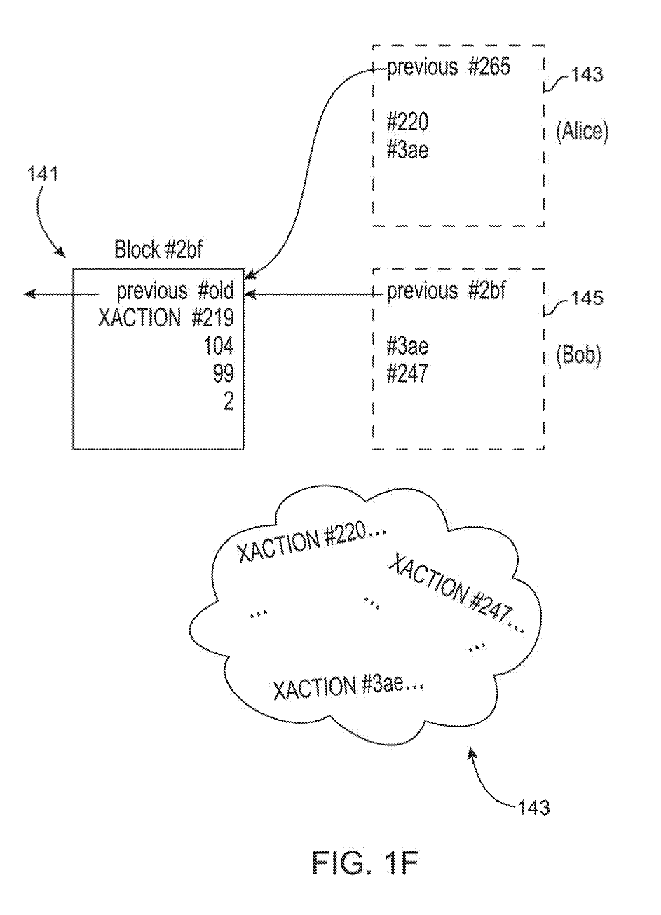

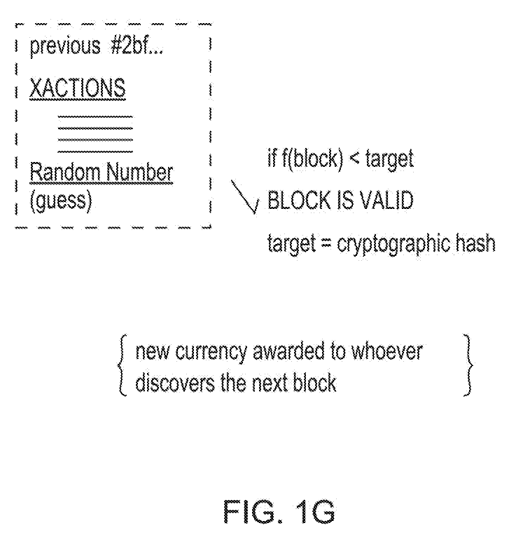

FIGS. 1A-1G depict an illustrative embodiment of a blockchain network 101 according to the present disclosure. This illustrative non-limiting embodiment is for purposes of demonstrating the concepts and providing context for the definitions provided above. The illustrative blockchain network 101 depicted in FIGS. 1A-1G is a specific use of blockchain technology to implement a cryptocurrency. Other implementations may use similar concepts and principles to develop different systems with different functional purposes.

Blockchain technology, sometimes also referred to as “blockchain,” is a particular type of distributed database. Blockchains can theoretically be used to store any type of data, but are particularly well-suited to environments in which transparency, anonymity, and verifiability are important considerations. Examples include financial projects, such as cryptocurrencies, auctions, capital management, barter economies, insurance lotteries, and equity crowd sourcing.

The technology is perhaps most easily understood through a simple and familiar example, such as “BitCoin™,” a cryptocurrency. A cryptocurrency is not entirely dissimilar from conventional currencies and, like a traditional currency, is essentially a medium of exchange. Traditional currencies are represented by a physical object—paper currency or minted coins, for example—which is “spent” by physically delivering it in the proper denominations to a recipient in exchange for a good or service.

However, for long-distance transactions, such as buying goods or services over the Internet, direct physical delivery is not feasible. Instead, the currency would have to be mailed to the recipient. However, this carries a very high risk of fraud. The recipient may simply keep the money and not deliver the purchased good or service, leaving the buyer without recourse. Instead, on-line transactions are typically carried out using electronic payment systems in which the transaction is processed, validated, and mediated by a trusted third party. This third party may be a bank, as in the case of a debit or credit card, or a third party service functioning as an escrow agent, such as PayPal™. Cryptocurrencies operate on this same principle, except that instead of using a financial institution or other third party to facilitate the transaction, the transaction is verified through a consensus reached via cryptographic proof.

The blockchain technology underlying most cryptocurrencies is relatively simple in principle, but the technical details can be difficult to understand. It may be simplest to understand the blockchain technology by comparing a conventional online transaction to a cryptocurrency transaction. An example of such a transaction is set forth in FIG. 1A. In the depicted FIG. 1A, a user 109A who will be referred to herein as “Alice” for convenience, is using the Internet 103 via a personal computing device 111A. If Alice 109A desires to transfer money to a third party, such as Bob 109B. Charla 109C, or David 109D, Alice 109A arranges the transaction through her bank 105 over the internet 103. The bank 105 keeps track of an authoritative master ledger 107 of the account balances of its members. Thus, if Alice 109A, who only has $100.00 in the bank 105, attempts to transfer $125.00 to Bob 109B, the bank 105 can determine quickly that Alice does not have sufficient funds to do so, and reject the transaction. Additionally, the bank 105 can use authentication techniques to determine with a high degree of confidence that the requested transaction does indeed originate from Alice 109A, and is not a fraudulent transaction instituted by Bob 109B, for example. This is done through login tokens, passwords, and other forms of user authentication common in the art.

Cryptocurrencies are similar in that Alice 109A can transfer value to other users 109B, 109C and 109D, except that instead of using a central transaction ledger 107 at a bank 105, each user of the cryptocurrency has his or her own separate copy of the ledger maintained on a blockchain system. This arrangement is shown in FIG. 1B. In FIG. 1B, Alice 109A has a copy of the transaction ledger 107A on her computing device 111A. Likewise, Bob 109B has a separate copy of the transaction ledger 1071 on his computing device 111B. In this system, if Alice 109A desires to purchase something from Bob 109B for five units of cryptocurrency, Alice 109A simply indicates to the system that Alice 109A wishes to transfer five units to Bob 109B. Each recipient of this message (Bob 109B, Charla 109C, and David 109D) will then update their individual copies of the ledger, 107B, 107C, and 107D, respectively.

While this eliminates the need for a central banking authority, it raises various technological problems. To implement this system, each user 109A, 109B, 109C, 109D has stored on his or her computing device 111A, 111B, 111C, 111D a copy of the ledger 107A, 107B, 107C, 107D. The ledger is essentially a computer file with data tracking all of the transactions that have taken place. Unlike a central bank, this data is not kept on just one computer system, but rather each user of the cryptocurrency has a separate and distinct version. Each individual computing device both stores the data and executes computations in a distributed fashion.

In such an environment, what is to stop Bob from faking a transaction by broadcasting a message to the network saying “Alice transfers 5 units to Bob” ? The answer is the use of digital signatures, generally via asymmetric cryptography. As shown in FIG. 1C, this system uses a pair of“keys” 115A and 115B, which are long strings of apparently random numbers and letters, having a mathematical relationship 110 with one another. These keys 115A and 115B are determined computationally for the user 109A by a computer at the same time. One key 115A is shared with the public (the “public key”) and one kept secret by the user (the “private key”) 115B.

Each of the keys 115A and 115B can be used to encrypt messages and files. The term “encrypt” in this context essentially means to encode or scramble the contents in an apparently random manner so that the original message (or file) is indecipherable. Due to the mathematical relationship between the keys 115A and 115B, a message encrypted by either key only can be decrypted by the other. Thus, if Alice 109A wants to send a verifiable message 113A to Bob 109B over a public network, Alice 109A need only tell Bob 109B what Alice's 109A public key 115A is, encrypt the message 113A using her private key 115B, and send the scrambled or encrypted message 113B to Bob 109B. When Bob 109B receives the scrambled message 113B, Bob 109B can use Alice's 109A public key 115A to unscramble the message 113B. If the message 113B does not unscramble correctly using Alice's 109A public key 115A, then Bob knows that the scrambled message 113B was not encrypted using Alice's 109A private key 115B. This should cause Bob 109B to be suspicious that the scrambled message 113B does not actually originate from Alice 109A. Thus, asymmetric cryptography can be used to confirm, at least, which encryption key was used to encode the message. Because only Alice 109A knows her private key 115B, a message that can be unscrambled using Alice's public key 115A can generally be assumed to have originated from Alice 109A.

This technology is also used to confirm the origin of cryptocurrency transactions. Cryptocurrency users have a computer file called a “wallet,” which is essentially a program that allows the user to store and spend cryptocurrency by submitting a transaction to the cryptocurrency's ledger. The “wallet” itself is protected by cryptography via a private key belonging to the user. Referring again to FIG. 1C, if Alice 109A wishes to spend her cryptocurrency, she encrypts the transaction message 113A, indicating that Alice's balance should be decreased by five and Bob's should be increased by five, using her private key 115B. Because the other users in the network all know Alice's public key 115A, each one can individually use the public key 115A to decrypt the encrypted message 113B and validate that it is from Alice 109A. However, neither Bob 109B nor anybody else can trick the system, because they do not know Alice's private key 115A for her wallet. If another user tries to fake a transaction from Alice 109A, it would have to be done using a different private key. This in turn means that the resulting scrambled message 113B will not decrypt properly using Alice's public key 115A. Thus, each node in the system is capable of independently validating whether any given transaction 113B actually originates from the person claiming to be spending his or her cryptocurrency.

The next problem with not having a centralized authority is the difficulty in determining if the person purporting to spend the currency actually has enough money to spend. Cryptocurrency blockchains do not actually keep track of balances, but rather only the history of transactions. To determine any given user's balance, all of the prior transactions involving that user must be traced back to the user's first transaction to determine his or her current balance. Because these transactions in turn depend upon the people transferring money to the user also having enough money to transfer, their transactions must also be confirmed. Thus, to validate the correct current balance of any given user, the entire history of all transactions in the entire blockchain must be validated. Fortunately, after this is done once, only incremental changes need to be updated or validated.

Validation is done through “links” to prior transactions. This is depicted in FIG. 1D. In the depicted embodiment of FIG. 1D, when Alice 109A attempts to send 5 units to Bob 109B, the transaction request 121A must include links to previous transactions 122A, 122B and 122C proving that Alice 109A has a net received cryptocurrency of at least 5 units. These links are called “inputs,” and each node checks them before accepting the transaction, to ensure that the sender has enough money to make the payment. Each individual linked transaction can also be verified as valid in the ledger.

As shown in the prior art embodiment of FIG. 1D, an illustrative transaction 121A purports to transfer five units from Alice 109A to Bob 109B. In cryptocurrency parlance this is represented as “increase Bob's balance by five and decrease Alice's balance by five.” As shown in the exploded view of 121B the transaction has unique identifier 120 and a list of inputs 122A, 122B, 122C and a list of outputs 124A and 124B. The depicted inputs in this illustrative embodiment are a reference to a prior transaction 122A in which one of the outputs was plus one to Alice 109A, a second prior transaction 122B in which one of the outputs was plus three to Alice 109A, and a third prior transaction 122C in which one of the outputs was plus 1.5 to Alice 109A. These three inputs, when combined, show that Alice 109A has a total of plus 5.5 in inputs. This is enough to make the transfer of five to Bob 109B, which is reflected in the first output 124A. However, since there is 0.5 left over, another output transfers the 0.5 residual back to Alice 121B. Once a given transaction has been used as an input, it is considered “spent” and cannot be used again.

However, this leaves a major security problem due to timing. In a conventional ledger, if the payor has only $100, and writes two checks for $100 to two different people, only one of the two recipients will be able to cash the check. This may or may not be the first person who attempts to cash the check, due to the timing of bank routing. When the first check arrives at the issuing bank, it will be cashed and the funds transferred to given to the redeemer. However, when the second check arrives, the bank will reject the payment for lack of funds.

However, with a cryptocurrency, since there is no central authoritative ledger, this does not work. That is, if Alice 109A tries to send five units to two different people, the transaction could “clear” with both, as each recipient may receive notice of the transactions in a different order. This type of fraud is known in cryptocurrency terms as a “double-spend attack.” This can give rise to a situation where one recipient accepts the transaction to Bob 109B and rejects the transaction to Charla 109C, but another recipient accepts the transaction to Charla 109C and rejects the transaction to Bob 109B. This in turn can cause the various copies of the ledger to get out of sync.

Conventional blockchain technology solves this problem using a combination of cryptography and game-theory. The transactions in a blockchain ledger are grouped into logical sets or collections of transactions. These groups are the “blocks” of a blockchain, and all transactions in a block are deemed to have taken place simultaneously. A block is “confirmed” or “canonical” if its content meets the blockchain's verification requirements, typically requiring that it falls below a certain threshold value when subjected to a cryptographic hash function. All pending transactions on the network which are not yet part of a canonical block are considered pending or unconfirmed, and may or may not be included in a future block. This arrangement is shown in FIG. 1F, in which the most recent confirmed block 141 contains a number of transactions, as well as a link to the prior block. In addition, the system contains a number of unconfirmed transactions 143 that are not part of any block in the system.

To confirm a transaction, a selection of transactions are grouped together in a proposed next block, along with a reference to the prior block and some random numbers known as a nonce. The block is then validated according to the requirements of the blockchain. In the conventional “proof-of-work” validation method, the proposed new block is subjected to a cryptographic algorithm, such as the secure hash algorithm (“SHA”), which converts the content of the block into essentially a random number represented as a long string of hexadecimal characters, known as a digest. The block is considered valid if this hash is less than a target value collectively determined by the blockchain network, meaning it has a large number of leading zeros. This is statistically rare with hashes, and any individual user would, on average, require several years' worth of computing effort to find a nonce that, when paired with the previous block number and an assortment of pending transactions, would result in a hash number less than the target value.

The computerized search for this nonce is known as “mining,” and each computer performing these calculations is called a “miner.” Once a user discovers a block that solves the equation, that user then broadcasts the new block to the network as the proposed next block in the chain. Although creating the block is computationally difficult, those who receive the block can trivially confirm that the block complies with the rules by running the proposed block, including the nonce, through the hash function, and confirming that it is below the target value. Thus, all transactions included in the proposed new block become confirmed or canonical, and the users will begin to “mine” the next block in the same fashion. This type of mining is known as “proof-of-work” because the computational difficulty of finding a compliant block is so high that the mere existence of such a block is itself sufficient proof that the work to find it was done, and the block is valid.

It should be noted that alternative forms of “mining” are possible. For example, in “proof-of-stake” validation method, the miners, also known as “validators,” place an amount of their stored cryptocurrency into a blockchain's stake mechanism. One of these validators is then chosen to create the next block, based on odds proportional to the relative size of their stake. That is, a miner that has staked 1% of the total staked value of the network has a 1% chance of being chosen to create the next block. If a miner creates a block that is on a fork which does not eventually become the canonical chain, or creates an invalid block, that miner can be penalized by losing some or all of the stake in the next block. While there is still some cryptographic computation involved in the creation of the block, it is not of the same magnitude as proof-of-work. This is just one exemplary implementation of the proof-of-stake mechanism to illustrate some of the differences, and is not limiting.

These validation methods can sometimes result in race conditions where two different users create different blocks that both meet the eligibility requirements of the blockchain, and each block may not have the same set of transactions in it. Other miners then work off the block each received first. This can mean that there are two active forks of the blockchain which different sets of miners are working on, depending on which block each miner received first. Referring again to FIG. 1F, suppose both Alice 109A and Bob 109B discover proposed new blocks that are both valid. Alice's block 143 includes two transactions #220 and #3AE and Bob's proposed block 145 contains two different transactions #3AE and #247. When Alice broadcasts her newly discovered block to the network some users will receive it first and begin to mine the next block following Alice's block 143. Other users, who received Bob's block 145 first will attempt to mine the next block following Bob's block 145. Each one of these lines of work is considered a fork, and neither is officially canonical until one has more value than the other.

In proof-of-work blockchains, value is determined by whichever chain has the most verified computational work associated with it, typically the one with the most blocks. Similarly, proof-of-stake blockchains place priority on whichever chain has the most staked value. Forks usually resolve themselves quickly, as the variability in computational power or network timing results in the next block in one fork being created before the next block in the other, and the rules of the system require all miners to use the most valuable fork. Thus, once one of the two forks becomes more valuable, all miners switch to mining the next block in that fork, and the other fork is discarded.

This also inhibits frauds from carrying out double-spend transaction attacks, because, to perpetrate the fraud, the fraudster must establish a longer, fraudulent fork containing invalid transactions. As a practical matter, this type of fraud is statistically and financially impossible to perpetrate for more than a few blocks at a time, as it requires one person or a group of people to out-perform the rest of the network combined.

The network is designed to find a new block quickly enough that fraudulent forks are discovered and discarded without damaging the integrity of the system. Experienced users know that transactions in the most recent couple of blocks are the least secure because they could be replaced if that block is disregarded in favor of a different fork, and so experienced users typically wait for the transaction to appear at least 3-6 blocks back in the chain. Depending on the specifications of the blockchain, this may take from several seconds to minutes or hours. At that point, it becomes statistically unlikely that the block is part of a fraudulent or discarded fork.

This block-mining and validation process is computationally intensive and requires powerful computers. This costs money, as the computers performing the validation consume electricity and divert processing power from other productive uses. To incentivize users to attempt these calculations, the person who mines or validates the next valid block is rewarded, typically with an amount of cryptocurrency. Thus, the process of finding the next block serves two purposes: (1) transaction validation; and (2) currency generation.

Another issue is prioritization. Because there is a large pool of unconfirmed transactions that could be potentially included in the next block, the sender of a transaction may optionally include a “transaction fee.” This fee is an amount of cryptocurrency which will be paid to the miner who successfully validates the next block including that transaction. Thus, to incentivize miners to include a given transaction in the next block, the sender includes a transaction fee. The higher the fee, the higher priority the miners will generally place on including the transaction in the next block.

These general principles are not limited to cryptocurrency. The blockchain is essentially a database and any type of data could be stored in the blockchain aside from transaction information, including software. For example, the Ethereum™ network allows programmers to write computer software that can be executed on a virtual machine shared across the entire blockchain network, in a system known as a computational blockchain. This is done by submitting the program instructions with a processing fee to pay miners for each line of code they execute. In such a system, a fee is paid to validate and include the code in the blockchain. Once the code is in the system, each machine in the network executes the code, performing the same set of calculations and storing the same values. This produces computational consensus in the system state without the need for a trusted authority, but results in substantial redundancy and replication across the network. This in turn makes contract executions expensive, inhibiting the use of a computational blockchain for computational work that can be performed conventionally (e.g., computational work of minimal complexity in a localized environment).

To incentivize execution, and prioritize projects, an execution fee is charged for every computational operation executed on the computational blockchain. Similar to a cryptocurrency, this fee acts as a “cryptofuel,” as the fee is paid to drive the execution of the smart contracts. Thus, the term “gas” is generally used to describe these execution fees. Gas is purchased by the sender of the programs from the blockchain miners who ultimately execute the code. However, gas is decoupled from the cryptocurrency used in the network (known as “ether” on Ethereum), because cryptocurrencies have values that can fluctuate wildly, whereas the computational cost of executing code on the virtual machine remains stable. Thus, gas represents a unit of processing complexity which remains generally static, whereas ether as a cryptocurrency is used to purchase gas. Thus, to execute code, enough gas must be purchased, and the market price for that gas in ether must be paid.

Thus, when a programmer submits a program to the network, the programmer must specify the maximum amount of gas he or she or she is willing to pay for the transaction, and the amount of “ether” he or she is willing to pay per unit of “gas.” If the amounts are too low, relative to the processing intensity of the code, miners will not run it, preferring instead to run other programs offered by programmers who are willing to pay more, incentivizing miners to prioritize their programs. If the program finishes execution faster than anticipated, any unused gas is reimbursed to the sender as cryptocurrency (ether).

In the reverse case, where not enough gas is provided to continue program execution, the miners are allowed to keep all spent gas, preventing attackers from forcing “useless” programs onto the network. Because the code all exists on the public blockchain, anybody can execute it, meaning all of the services provided by the various programs are available to run by anybody in the world, providing the external account holder is prepared to pay enough for the required gas.

Blockchains have a number of advantages. Logically, blockchains are essentially an extension of the array data storage primitive, in that each new element, or block, must follow specific, verifiable rules to be eligible for addition to the chain, and verification usually is based at least in part on prior elements/blocks already added, creating a path-dependent “chain.” Blocks that do not follow the blockchain's rules are ignored or discarded, and a form of computational consensus-reaching is used to identify the “right” path in the event of a fork.

As shown in the above examples, blockchains can be used to coordinate data storage across multiple independent computer systems. Each system can independently verify the integrity of the entire chain by analyzing each block under the governing rules. This allows multiple independent parties to share identical information without the requirement of mutual trust. So long as the blockchain's rules are properly designed, it is statistically all but impossible for false or malicious blocks to be added.

A goal of all blockchains is the reduction of transaction fees. The lower the transaction fees are, the more profitable it becomes to use the blockchain for sales and purchases. However, the overall transaction costs must be greater than the operational costs for the miners, or there is no incentive to mine, which is vital to validating transactions. With cryptocurrencies, the processing complexity of adding a transaction to a block has made it difficult for conventional blockchain implementations to develop a competitive fee schedule that could overtake traditional payments systems, such as credit cards and bank transfers, and facilitate the development of a viable micropayment economy.

Additionally, a key feature of blockchain networks is the absence of a central authority to validate transactions, instead using consensus computing to validate transactions. However, because the consensus is based in part on the passage of time, blockchains are generally unsuitable for instantaneous validation of transactions. This causes problems because users in a micropayment economy expect instant payment processing and immediate access to content. Thus, the technical nature of the blockchain imposes a limit (timing) that is directly at odds with the needs of users. To overcome this problem, the systems and methods described herein utilize a separate processing machine to effectively cache blockchain transactions in a local shadow ledger that have been authenticated locally by a central authority service before they are pushed out onto the blockchain. Because the central authority server effectively manages a specific subset of the blockchain, it can authenticate these transactions without fear of double-spend attacks or fraudulent transfers.

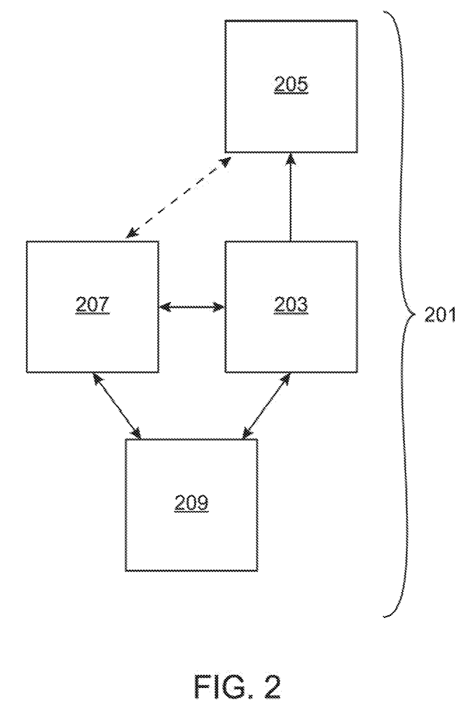

FIG. 2 depicts a high-level abstraction of the major component systems in an embodiment. In the depicted embodiment of FIG. 2, the systems and methods 201 comprise a blockchain network 205, a centralized authority system 203, and at least one user accessing the centralized authority system 203 from a user computer 207. Generally speaking, the centralized authority system 203 is a server system 203. As described in more detail elsewhere herein, the users typically interact with the system via a web browser, but this is by no means limiting. Also depicted in FIG. 2 is a third-party computer 209 which communicates with both the centralized authority system 203 and the user computer 207. As described in more detail elsewhere herein, the third-party computer 209 generally provides a service desired by the user of the user computer 207, and communicates with the central authority system 203 to facilitate payment by the user of a fee for access to a services provided by the third-party computer 209. Thus, the systems and methods described herein generally use at least four different computers: a central authority system 203; a user computer 207; a third-party computer 209; and at least one other computer system hosting a node in the blockchain 205. In any given implementation, these roles are functionally reversible. Thus, the term “first computer” may be used to refer to a user computer and “second computer” used to refer to a third-party or participant computer, and vice-versa.

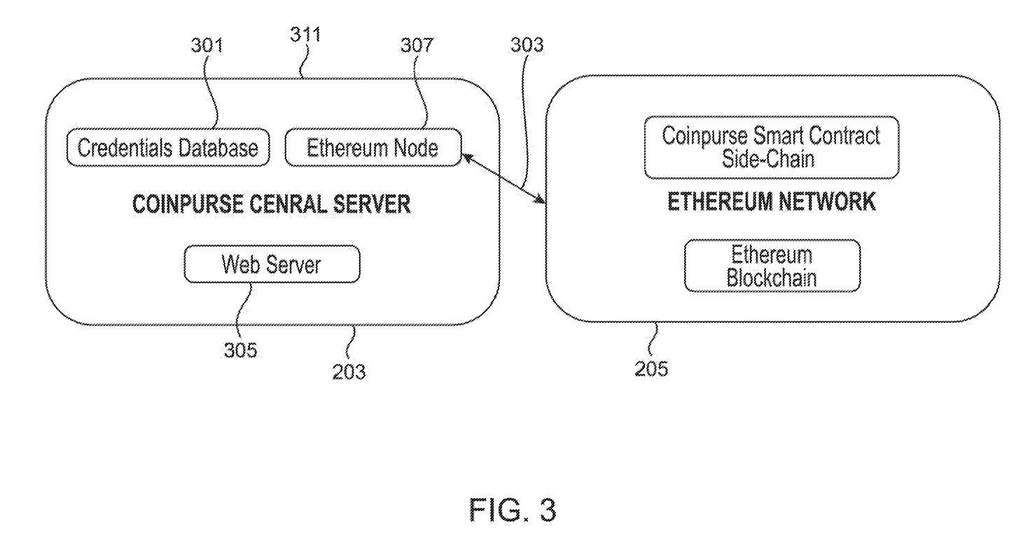

The systems and methods described herein use a computational blockchain 205, such as that depicted in FIGS. 2 and 3. FIG. 3 also depicts an embodiment of a central authority system 203 according to the present disclosure, and its relationship to the blockchain system 205. In the depicted embodiment of FIG. 3, the central authority system 203 comprises a computer server 311 communicating 303 over a telecommunications network. The depicted server 311 is a logical server, and may comprise one or more standalone physical computer systems or one or more virtual servers using the resources of one or more physical computer systems, as would be well-understood to a person of ordinary skill in the art. The depicted server 311 further comprises a web server 305, a node 307 on the blockchain network 205, and a database 301. The depicted blockchain network 205 is Ethereum™, but any computational blockchain now existing or in the future developed may be used.

The depicted web server 305 may be any web server now known in the art or in the future developed or used. Examples of web servers include Apache™, IBM™, Microsoft™ Internet Information Services (IIS), and other implementations, such as, without limitation, the Perl HTTP::Server::Simple module. These and other web servers are well known and familiar to a person of ordinary skill in the art.

The depicted node 307 is a node in the blockchain system 205. In the depicted embodiment, the node 307 is a node in the Ethereum™ blockchain network 205. The server 311 operates and controls the node 307 to interact with the blockchain 205 and to manage the placement and execution of smart contracts thereon.

The depicted database 301 manages data specific to the present systems and methods, and is maintained separately and independently of the blockchain 205. By way of example and not limitation, the depicted database 301 may comprise credential data for one or more users. The credential data may comprise authentication information for facilitating secure user login/logout and usage of the services produced by the central authority system 203. Users need not also have separate nodes in the blockchain 205 independent of the systems and methods described herein, though they may. However, to the extent any users are also independent nodes in the blockchain 205, any such interaction is independent of the users' interactions with the blockchain 205 via the central authority system 203.

Operationally, the central authority system 203 is owned, controlled, and operated by a specific company or enterprise, and establishes a private or semi-private micropayment ecosystem implemented via smart contracts on the blockchain 205, which may be public.

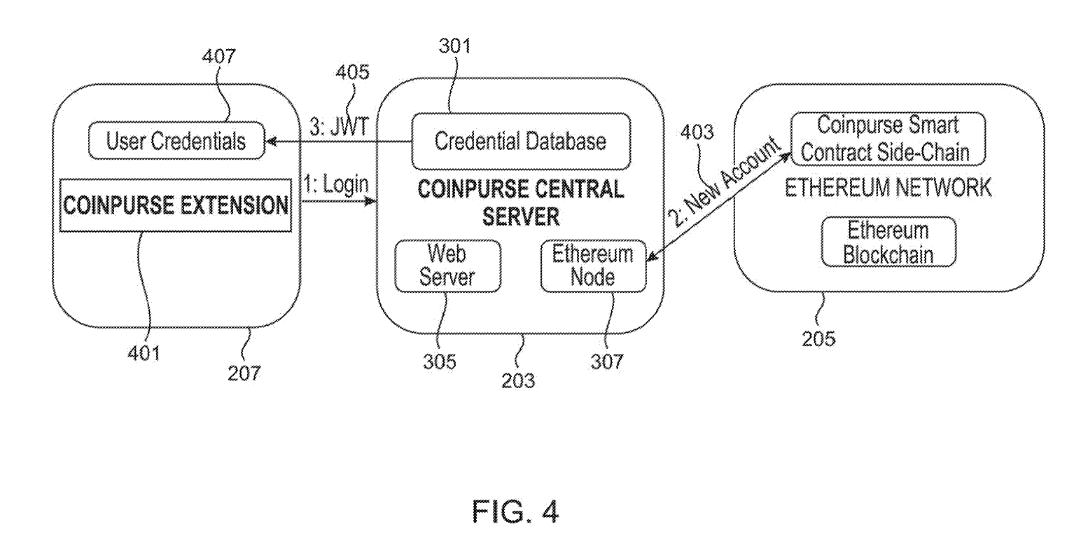

As shown in the depicted embodiment of FIG. 4, a user uses the systems and methods via a user computing device 207. The user computing device 207 has installed thereon software 401 configured for interacting with the server 203. The software 401 may comprise any type of software, including but not necessarily limited to, standalone desktop application software, a mobile device application, a plugin, module, or extension, part of the operating system, and so forth. In the typical case, the user will download the software 401, a web browser module 401 or plugin 401. A person of ordinary skill in the art will understand that users often have multiple computer systems 207 and may install various software 401 on various devices 207 to access the server 203 from each. Such software 401 and devices 207 may be referred to collectively as the “client” for simplicity.

The user may then register an account with the server 203. Techniques for user registration are venerable and well-known. Typically, users complete a form with some amount of information about themselves and supply authentication credentials, usually in the form of at least a username-password combination. Other forms of authentication are also possible, such as two-factor or multi-factor authentication.

The server 203, in response to registration attempt or successful registration, creates 403 a public address and private key associated with the account for use in the blockchain 205. This information is generally stored in the database 301. These keys are generally generated using asymmetric cryptography. The server 203 may also authenticate the client software 401, such as by simply maintaining an open network session (e.g., a TCP session) or sending 405 an access token (preferably encrypted), such as a JSON Web Token (“JWT”) [RFC 7519.] or another secured token or cookie as would be known to a person of ordinary skill, to the client 207, 401. The authentication token may be later presented. These and other techniques for authenticating software are known in the art.

The server 203 effectively implements a virtual currency. A “virtual currency” should not be confused with cryptocurrency. Whereas the supply and distribution of a cryptocurrency is generally metered and controlled by the rules of a blockchain network and is effectively beyond manual control, an amount of virtual currency can be created on demand, and is more akin to a point system. Thus, the term “virtual currency” as used herein refers to a non-fiat digital currency exchangeable in a defined ecosystem and created on-demand. Implementations of similar concepts are commonly used in mobile gaming to limit player progress by requiring a certain amount of currency to be accumulated to advance in the game, but distributing such currency at a frustratingly slow pace, or requiring players to engage in activities that generate revenue for the game developer (such as watching advertisements, buying products, or taking market research surveys) to get the currency. Players who wish to advance more rapidly may then simply buy an amount of the needed currency immediately. The currency is created and awarded to the player on-demand.

However, such in-game currencies are more limited than the present systems and methods. For example, they have value only within the context of the game. Such currencies cannot be used to purchase other goods or services outside of the game's internal economy, and the game creators generally do not provide typical financial services. The in-game funds are typically non-redeemable, meaning they have no fiat value once purchased, and the games do not maintain any detailed or accessible accounting records for in-game currency transactions. While this allows the game creators to manage costs and create a value-storage system to easily administrate the user base, it does not allow the in-game currencies to be used for any real-world merchant or payment activities. If the developer discontinues operations, the game currency is simply lost.

The systems and methods described herein operate by the exchange of a virtual currency implemented via smart contracts on a public blockchain. Once registered and authenticated, users may acquire virtual currency by either purchasing it directly (e.g., from the organization operating the central authority system 203) or by engaging in certain activities with partnered participants. Users may also exchange virtual currency between accounts.

To maintain the “free” nature of the system, users will typically accrue virtual currency by interacting with third-party service providers willing to participate in the virtual currency economy, referred to herein as “participant.” For example, the user may respond to a marketing survey, answer a question, provide consultation services, watch an advertisement, or perform any number of other programmatically verifiable activities or services.

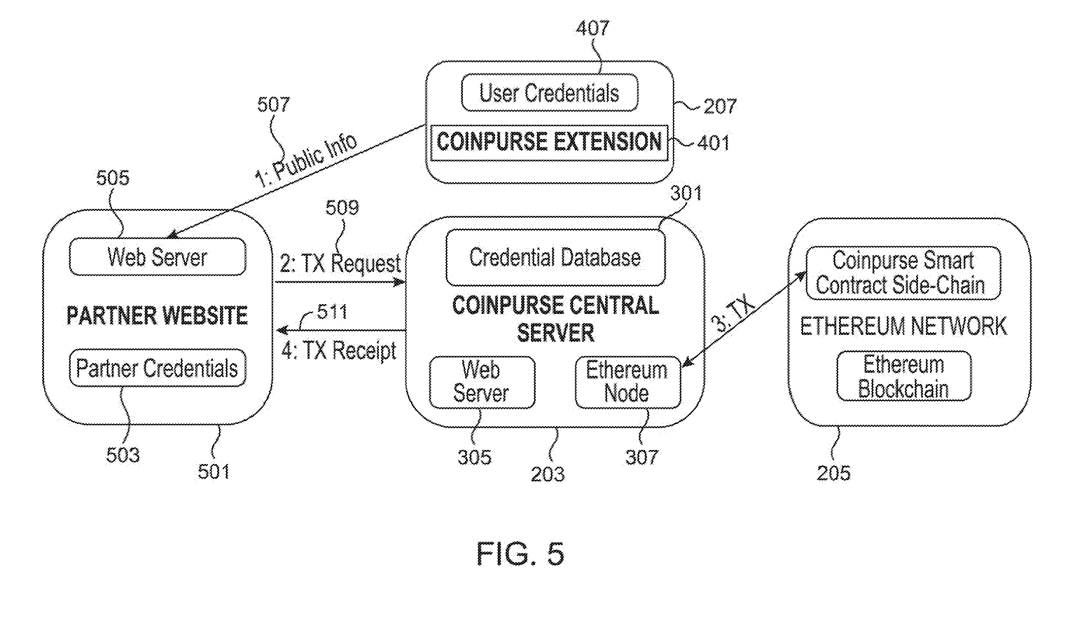

In the depicted embodiment of FIG. 5, the participant operates a website or other service via a third-party server 501. The server 501 receives 507 the user's public information (e.g., a public key), such as in an HTTP header of a request to its web server 505 or in the body of a POST message, and then uses the HTTP protocol, or other telecommunications protocol, to deposit the appropriate amount of virtual currency in the user's account via communications with the central authority's server 203. As described elsewhere herein, this is done via a shadow ledger.

Each participant may have its own unique credentials 503 with respect to the server 203, such as, without limitation, an encrypted access token (such as, but not necessarily limited to, a public address), in the same manner as a regular user. To send virtual currency to a user, the participant transmits 509 a transaction request to the server 203 with data indicating the type of transaction, the recipient (i.e., the user identified by public information 507), the participant's credentials, and any other transaction-specific data, such as the amount of virtual currency.

The server 203 may then perform whatever system-specific calculations are necessary to process the transaction. For example, in a virtual currency economy where the participant must also acquire sufficient currency, the participant's account in the database 301 may be checked to ensure that there is sufficient currency available. If there is, the transaction may be permitted, resulting in the account balance for the partner being reduced by the amount of requested currency, and the account balance of the user being increased by the same amount. As described in more detail elsewhere herein, the local copy operates as a “shadow ledger” reflecting a superset of a public ledger maintained on the blockchain 205.

It is important to understand that these transactions, while publicly available on the blockchain 205, are nevertheless effectively anonymous, because the only identifying data is the public address information 507, which does not identify any individual or enterprise. As described elsewhere herein, each individual transaction is not necessarily committed to the blockchain 205 immediately, but rather a number of transactions are queued for bulk processing in a shadow ledger. This reduces the transactional overhead.

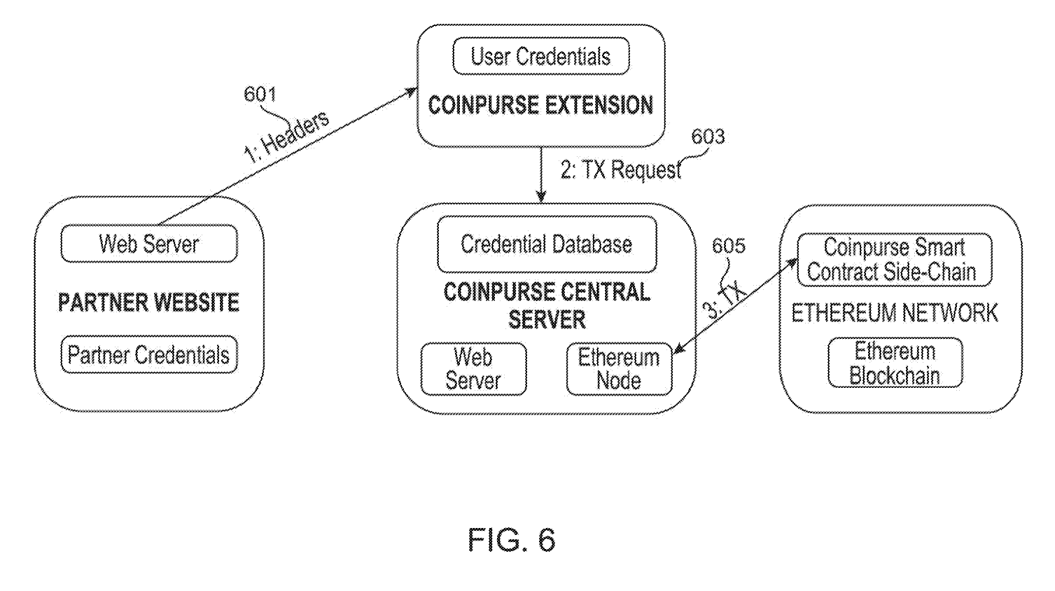

To spend virtual currency, these steps are simply reversed as depicted in the embodiment of FIG. 6. For example, in the depicted embodiment of the FIG. 6, when a user requests content from a web site which is using the virtual currency system, the user's client software, this time in the form of a browser extension 401, examines the headers of the HTTP response before fully downloading the page. Headers from participant web sites may contain fields including the cost of accessing alternative or exclusive content using the virtual currency. Thus, the software may redirect the user to the appropriate content before downloading the entire document. Alternatively, the participant website may include Document Object Model manipulations in any requested page to interact with the extension and transmit transaction requests. These examples are not the only ways to communicate with a software client, and a person of ordinary skill in the art will understand that many options to transmit the required information exist.

The extension 401 may then prompt the user for authorization to pay the requested amount, and carry out the transaction process. If the user declines, the web site responds with alternative lower cost or advertising content or denies the request entirely. If the browser extension is not present, then the user simply receives the unaltered content with advertising and other such content intact. The transaction process thus involves at least two transactions—the spending of virtual currency in the server system, and processing a smart contract on the blockchain 205. To request the transaction, the client 207/401 reads the header fields 601 to determine the transaction type, amount, recipient, and the requested resource (e.g., web page, video, content, or service). That information is then passed 603 to the server 203, such as in the form of an HTTPS transaction request 603. The server 203 then processes the transaction: it queries the blockchain and server state for account information, including effective balance, and compares that with the provided transaction information to determine if the transaction would succeed if formally posted to the blockchain. The server 203 also considers transactions posted to the shadow ledger but not yet posted to the blockchain to confirm that the transactions are valid based on other transactions that the central authority server 203 is aware will be posted to the blockchain, but have not yet been posted.

Once it has been determined that the transaction can be successfully posted (e.g., by the server 203), the server 203 sends a transaction receipt/notification 701 to the participant server containing the information supplied for the transaction as well as any optionally specified information from the user's request 603. The participant server 501 responds to this notification 701 with an encrypted authentication token or other access-permitting means 703, or may simply acknowledge the transaction with an empty response if it is operationally unnecessary to require proof of payment and validated receipts (such as in the case of charities). The central authority system 203 then transmits a receipt for the payment plus this token or response 705 to the user computer 207.

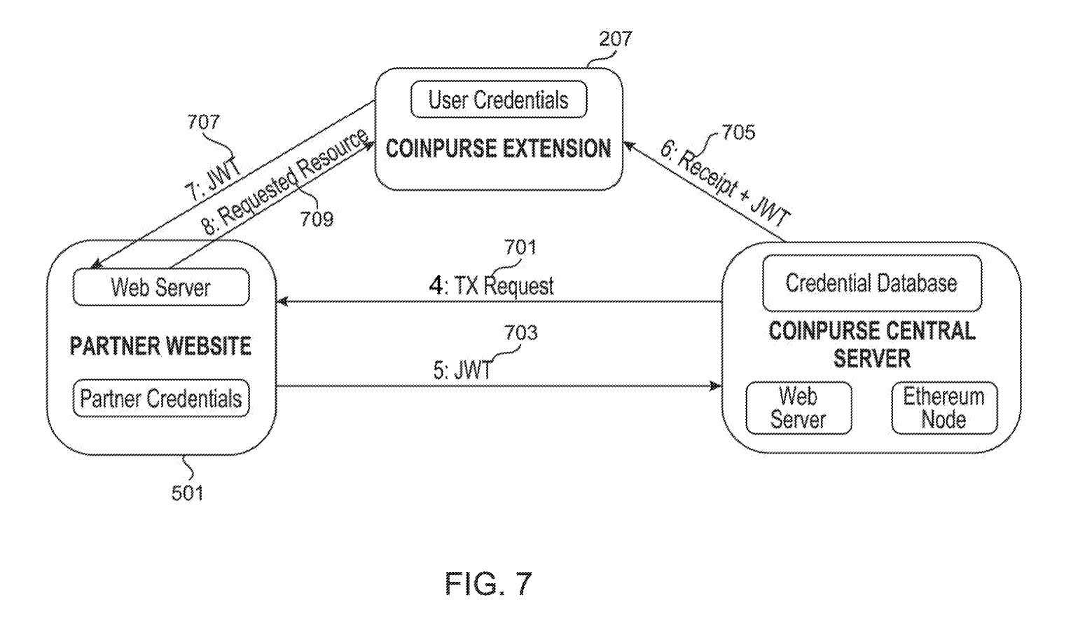

The user computer 207 may then transmit 707 a provided token to the participant computer 501 to complete the loop and authenticate the purchase. The participant computer 501 then serves the requested resource 709 to the user computer 207. In the depicted embodiment of FIG. 7, this authentication and exchange is performed by use of a JSON web token, but other means for this type of access authentication are known and could be used instead, including but not necessarily limited to, any arbitrarily encrypted access token or functional equivalent.

These systems make it possible to reduce or eliminate the amount of advertising on a website or other online service by allowing users to make small micropayments in the form of virtual currency to remove advertisements or simply pay for the service. In return, users may perform simple tasks which have value to the advertisers or website owners in exchange for currency to spend in this virtual economy. This type of flexible, pseudo-anonymous payment system allows content providers and users alike the opportunity to create more streamlined and simpler online service experiences, while also providing compensation to the website service provider. Websites can remove or reduce advertisements on their pages, making them cleaner and more pleasing to users, and can also replace paid membership and subscription systems with a pay-per-view model, allowing user to pay per page served or per session. By using an encrypted access token, there is no need for databases of users, as the extension 401 functions like a credit card, allowing the immediate purchase of real world goods and services with virtual currency.

An aspect of the present systems and methods is that some or all transactions to be, or that have been, posted on the blockchain are also tracked in a shadow ledger. As used herein, “shadow ledger” means as local ledger containing transactions that have been verified by the server 203 but may not have been posted to the blockchain. The shadow ledger is thus both a subset of the blockchain (containing only transactions pertinent to the virtual currency) and a superset (containing transactions that have not been posted to the blockchain but will be). This provides a number of benefits. First, this allows for batching, meaning a number of individual, potentially unrelated transactions may be queued up and posted to the blockchain in a single group transaction to reduce overhead. The server tracks the verified, but unposted (to the blockchain) transactions and checks those records for conflicts or other problems before allowing a transaction.

This may be accomplished through a method of a smart contract which accepts the batch from a pre-authorized party and processes each transaction individually. These batched transactions may be sent from a single account or may be sent from an arbitrary number of accounts to one or multiple recipients. This batch method has the advantage of requiring fewer interactions with the blockchain while still processing the same amount of information, and thus lower transaction fees.

In an embodiment, twenty transactions are batched, though the specific number may vary from embodiment to embodiment. In practical terms, the transaction cost savings are subject to the law of diminishing returns, and tend to asymptotically approach a singularity. Because delaying posting may cause operational disruption, a balance should be struck between batching to reduce transaction costs, and promptly posting transactions for execution. Generally, older transactions should be preferred over newer transactions, and it is preferable that the batching method attempt to maximize the number of transactions that may be submitted to the blockchain for inclusion in each block. The particular manner of doing so depends upon the specific rules of the blockchain, and simply requires an understanding of the particular blockchain's rules and the implementation of ordinary programming techniques to implement maximization algorithms, many of which are simple and well-known.

In an embodiment, the maximization technique comprises submission to the blockchain by batching on a per-account basis. That is, transactions for a given user account may be queued on the server and submitted in a batch for the user. This is because users will often accrue a number of transactions together. For example, if a user is browsing a number of participating sites or using a number of participating services during a web session, the user may accrue a plurality of transactions in a short period of time. Because of this common user behavior, the system may be programmed to begin batching after receiving a transaction for a given user after a predetermined amount of time, and to submit the transactions once the user has no transaction activity for a predetermined amount of time.

Because transactions in a blockchain depend on prior transactions, batching presents a unique problem in that the status of the blockchain once these batched transactions are submitted must be known in order to validate future transactions. To do so, the system may implement a “virtual blockchain,” which is essentially a private copy of the public blockchain, which is separately and privately maintained to simulate the posting of batched transactions and ensure that all transactions are valid and will be accepted once submitted. Provided each transaction is submitted to the canonical blockchain in the same order as the virtual blockchain, the ultimate results of the transactions will be the same. This facilitates validating transactions far in advance of posting to the public blockchain so that batching can be implemented.

The blockchain aspect provides a number of advantages over conventional systems. While it may be possible, in an embodiment, to implement the virtual currency infrastructure described herein, the blockchain aspects provide a number of useful features. First, the blockchain provides an immutable, public record of all transactions, providing confidence to users, and partners, that an enterprise implementing this virtual currency will not simply steal their investment, or lose it due to business continuity failures. Further, because the blockchain forms the backbone of both ledger activity and smart contract execution, there is a guaranteed uptime and protection from loss, in addition to simple error correction and transactional history validation, all via the public ledger. Additionally, the blockchain provides for trust and transparency, since each account and transaction can be independently audited and confirmed by anybody. Further, those who are already familiar with the use of blockchain technologies will be attracted to the service, providing a small amount of free publicity for any enterprise implementing a virtual currency using these systems and methods. Administratively, anyone in the world may instantly query the database without tying up server time, and can run automatic reports with relatively low costs compared to a hosted database solution. This further reduced the overall costs of the system, and lowers development and maintenance time. Additionally, present regulations make cash asset transfers more difficult, due to regulatory activity around the use of payment cards and bank transactions. With the blockchain, it is easier to transmit value while avoiding the costs and overhead of compliance with regulatory schemes.

The accountability of this system is also transparent because it can be confirmed when and how the transactions took place. Further, because transactions posted to the blockchain are batched, the transaction costs are lowered to the point where the micropayment economy is feasible. Currently, there is no economically viable way to use blockchain technology on a microtransaction basis because the transaction costs ultimately meet or exceed those of conventional payment card systems.

In an embodiment, the systems and methods may comprise further features. For example, a “pay per serving” model may be implemented, on web pages, music, videos, podcasts, games, new books, news articles, programs, mobile apps, and the internet-of-things, to create transactions. In a mobile environment, these systems and methods may be used to permits apps to access users' public information to create transactions. Similarly, websites accepting donation per page which are otherwise free, such as Wikipedia, may use these systems, as may charities, including conventional charities.

In an embodiment, the transactions may be fully anonymized, such as through the use of a transaction scrambling algorithm, in exchange for a higher transaction fee. In another embodiment, the browser extension 401 may communicate directly with the smart contract system and bypass the central authority for further decentralization.

In another embodiment, a catalog system may be implemented with top value generating opportunities from advertisers, creating an intuitive and easy shopping experience for users. In a still further embodiment, an “open-world” is implemented whereby transfers between other cryptocurrencies may be recorded, initialized, or verified using the centralized transaction process described previously.

In a still further embodiment, the systems and methods implement as-needed security, whereby users may receive additional permissions, such as increased transfer limits and withdrawals, when they supply required credentials, such as a driver's license or birth certificate, or increase their security settings, such as two-factor authentication, or they log in more often, and so forth.

In yet another embodiment, the central authority retains all blockchain access and prevents users from manipulating their accounts from a private blockchain node by maintaining their private keys. Because all transactions may now be sent only through the central authority which can control the transaction queue of each user, successful transaction receipts may be confidently returned well before the transaction has been formally submitted to the blockchain. This provides an advantage over typical cryptocurrencies, which require that users wait for several block confirmations before completing their transaction.

The transactions described herein may be implemented, in whole or part, via smart contracts on a blockchain, preferably a public blockchain, such as Ethereum. This provides transparency, security, and stability. For example, the virtual currency may have a cash-equivalent value established by flat by the issuing enterprise, which exchange rate is kept at a fixed amount to avoid inflation or deflationary forces imparted by fluctuations in cryptocurrency markets. This in turn means arbitrage will force the price to a fiat rate. By using the blockchain, the virtual currency has market value outside of the system. In the event that a given enterprise discontinues operations, for example, the smart contracts remain on the blockchain, and can be executed and utilized by other, independent actors. This protects the investments of the users, both business and consumer, in the system.

It will be appreciated by a person of ordinary skill in the art that while the present disclosure primarily written with respect to advertising on web-sites, the principles are equally applicable to other computer-based content or services. For example, and without limitation, the systems and methods described herein are applicable to in-app content commonly used with mobile device applications and distribution platforms (e.g., the Apple™/iOS app ecosystem), as well as desktop applications and distribution platforms (e.g., the Steam™ platform for desktop computer games). Furthermore, the systems and methods described herein may be used to complete the sale and purchase of any goods, services, or ideas as envisioned by the end users.

While this invention has been disclosed in connection with certain preferred embodiments, this should not be taken as a limitation to all of the provided details. Modifications and variations of the described embodiments may be made without departing from the spirit and scope of this invention, and other embodiments should be understood to be encompassed in the present disclosure as would be understood by those of ordinary skill in the art.

1. A method for immediate validation of a blockchain transaction comprising:
providing a blockchain network operated in accordance with a ruleset;
providing a first computer;
providing a second computer;
providing a first public key identifying a first account on said blockchain network, said first public key being associated with said first computer;
providing a second public key identifying a second account on said blockchain network, said second public key being associated with said second computer;
providing a central authority server, said central authority server being a node in said blockchain network and operating a shadow ledger for said blockchain network in accordance with said ruleset;
receiving, at said second computer, said first public key and a transaction request using said public key;
receiving, at said central authority server, an access token for said second computer and data for said transaction request, said data comprising at least said first public key and said second public key;
said central authority server verifying, based on said access token, said first public key, and said second public key that said transaction is valid on said blockchain network according to said ruleset; and
receiving, at said second computer, a result of said verifying step indicating that said transaction is valid.

2. The method of claim 1, wherein said blockchain network implements a cryptocurrency.

3. The method of claim 2, wherein said blockchain network further implements a virtual machine configured to execute smart contracts.

4. The method of claim 1, wherein said central authority server includes a first private key corresponding to said first public key and formed using asymmetric cryptography.

5. The method of claim 1, wherein said transaction request comprises a request to perform a programmatically verifiable activity.

6. The method of claim 1, further comprising:
conducting the requested transaction; and
at said central authority center, posting said transaction to said shadow ledger.

7. The method of claim 6, further comprising:
repeating said receiving steps, said verifying steps, said conducting step, and said posting step a plurality of times such that said shadow ledger comprises a plurality of transactions; and
posting said plurality of transactions in said shadow ledger to said blockchain.

8. The method of claim 6, further comprising receiving, at said second computer, a receipt for said conducted transaction.

9. The method of claim 1, wherein said verifying step comprises verifying that said transaction is permitted by said ruleset as applied to the combination of said blockchain and said shadow ledger.

10. The method of claim 1, wherein said transaction data further includes an amount of a virtual currency.

11. A method for immediate validation of a blockchain transaction comprising:
providing a blockchain network operated in accordance with a ruleset;
providing a first computer;
providing a second computer hosting a resource;
providing a first public key identifying a first account on said blockchain network, said first public key being associated with said first computer;
providing a second public key identifying a second account on said blockchain network, said second public key being associated with said second computer;
providing a central authority server, said central authority server being a node in said blockchain network and operating a shadow ledger for said blockchain network in accordance with said ruleset;
receiving, at said second computer, a request for said resource;
receiving, at said first computer from said second computer, transaction data for a transaction to access to said content, said transaction data including said second public key;
receiving, at said central authority server from said first computer, said first public key and a transaction request including said transaction data and said second public key;
said central authority server verifying, based on said received transaction request, said first public key, and said second public key that said transaction is valid on said blockchain network according to said ruleset;
receiving, at said second computer from said central authority server, a result of said verifying step indicating that said transaction is valid;
receiving, at said central authority server from said second computer, an authentication token for said permitted transaction;
receiving, at said first computer from said central authority server, said authentication token;
receiving, at said second computer from said first computer, said authentication token; and
said first computer accessing said resource hosted by said second computer.

12. The method of claim 11, wherein said blockchain network further implements a virtual machine configured to execute smart contracts.

13. The method of claim 11, wherein said central authority server includes a first private key corresponding to said first public key and formed using asymmetric cryptography.

14. The method of claim 11, wherein said receiving, at said first computer from said central authority server, said authentication token further comprises receiving, at said first computer from said central authority server, a receipt for said transaction.

15. The method of claim 11, wherein said resource is modified content of a web page containing marketing content, said modified content omitting said marketing content.

16. The method of claim 11, wherein said resource is an offer or sale of goods or services.

17. The method of claim 11, further comprising at said central authority center, posting said transaction to said shadow ledger.

18. The method of claim 18, further comprising:
repeating said receiving steps, said verifying step, and said accessing step a plurality of times such that said shadow ledger comprises a plurality of transactions; and
posting said plurality of transactions in said shadow ledger to said blockchain.

19. The method of claim 11, wherein said transaction data includes an amount of a virtual currency.

20. The method of claim 11, wherein said verifying step comprises verifying that said transaction is permitted by said ruleset as applied to the combination of said blockchain and said shadow ledger.
